(19) United States
(12) Patent Application Publication
(10) Pub. No.: US 2014/0063561 A1
(43) Pub. Date: Mar. 6, 2014

(54) IMAGE PROCESSING APPARATUS, IMAGE FORMING APPARATUS, AND IMAGE PROCESSING METHOD

(71) Applicant: Takayuki ENDOH, Kanagawa (JP)

(72) Inventor: Takayuki ENDOH, Kanagawa (JP)

(73) Assignee: RICOH COMPANY, LIMITED, Tokyo (JP)

(21) Appl. No.: 14/012,079

(22) Filed: Aug. 28, 2013

(30) Foreign Application Priority Data
Aug. 28, 2012 (JP) 2012-187471

(51) Int. Cl. H04N 1/00; H04N 1/203

(52) U.S. Cl. CPC H04N 1/0097; H04N 1/2032
USPC 358/408

(57) ABSTRACT

An image processing apparatus includes an image data storage unit, parameter storage units, a signal generator, a reading unit, and an image processing unit. The image data storage unit stores therein a plurality of pieces of image data input from scanning units. The parameter storage units are provided respectively corresponding to the scanning units and store therein parameters respectively set for the scanning units. The signal generator generates a signal for specifying an order of reading the image data from the image data storage unit and for specifying one of the parameter storage units that stores therein the parameter to be used for the read image data. The reading unit reads the image data in the order specified by the signal. The image processing unit performs image processing on the read image data using the parameters stored in the parameter storage unit specified by the signal.

### CROSS-REFERENCE TO RELATED APPLICATIONS

The present application claims priority to and incorporates by reference the entire contents of Japanese Patent Application No. 2012-187471 filed in Japan on Aug. 28, 2012.

### BACKGROUND OF THE INVENTION

1. Field of the Invention

The present invention relates to an image processing apparatus that performs image processing of a plurality of pieces of image data input from a plurality of scanning units, an image processing method, and an image forming apparatus that includes the image processing apparatus.

2. Description of the Related Art

Image forming apparatuses including an image reading device for reading images on both sides (the front side/the back side) of a document at the same time have physically different sensors, that is, a charge coupled device (CCD) image sensor and a contact image sensor (CIS) sensor as sensors for reading images, due to the limitation of installation space in the apparatus, for example.

In such an image forming apparatus, therefore, image processing is performed on each piece of image data obtained from each of the above-described different sensors using different parameters, thereby eliminating the difference of the image quality of the images to improve the image quality. Actually, the image forming apparatus selects parameters (parameters for the front side or parameters for the back side) depending on whether the image data being processed is image data on the front side (front-side image data) or the back side (back-side image data) of the document, sets the selected parameters, and then performs image processing on the image data.

With conventional technologies in the related art, the parameters for the front side or the parameters for the back side are selected using software executed by a CPU that totally controls the apparatus, before image processing on image data is started, and set on hardware (an application specific integrated circuit, i.e., ASIC) that performs image processing (refer to Japanese Laid-open Patent Publication No. 2008-236166).

There is a problem, however, in that with the above-described method in which parameters are selected and set by the software before image processing is started, if a large number of parameters are to be set, it takes a long time to complete the setting of the parameters. In addition, parameters need to be set every time image processing is started like when image processing on the front-side image data ends and image processing on the back-side image data starts, or when image processing on the back-side image data ends and image processing on the front-side image data starts. This requires a long time for processing image data, thereby decreasing the productivity as an image processing apparatus.

### SUMMARY OF THE INVENTION

According to an embodiment, there is provided an image processing apparatus that includes an image data storage unit, a plurality of parameter storage units, a signal generator, a reading unit, and an image processing unit. The image data storage unit stores therein a plurality of pieces of image data input from a plurality of scanning units. The parameter storage units are provided respectively corresponding to the scanning units and store therein parameters respectively set for the scanning units. The signal generator generates a signal for specifying an order of reading the image data from the image data storage unit and for specifying one of the parameter storage units that stores therein the parameter to be used for the read image data. The reading unit reads the image data in the order specified by the signal. The image processing unit performs image processing on the read image data using the parameters stored in the parameter storage unit specified by the signal.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating the hardware structure of an image forming apparatus capable of mounting an image processing apparatus according to an embodiment of the present invention;

FIG. 2 is a diagram illustrating the hardware structure of the image processing apparatus according to the embodiment;

FIG. 3 is a diagram illustrating the hardware structure of an image processing ASIC_A included in the image processing apparatus illustrated in FIG. 2;

FIG. 4 is a diagram illustrating the hardware structure for selecting a register based on a register designation signal;

FIG. 5 is a diagram illustrating the difference between the processing time required when parameters are set in a software manner and the processing time required when parameters are set in a hardware manner;

FIG. 6 is a diagram illustrating the input timing of signals according to a first example;

FIG. 7 is a diagram illustrating the input timing of the signals according to a second example;

FIG. 8 is a diagram illustrating the input timing of the signals according to a third example;

FIG. 9 is a diagram illustrating the input timing of the signals according to a fourth example;

FIG. 10 is a diagram illustrating the input timing of the signals according to a fifth example; and

FIG. 11 is a flowchart illustrating an example of the procedure of image processing performed by the image processing apparatus.

### DETAILED DESCRIPTION OF THE PREFERRED EMBODIMENTS

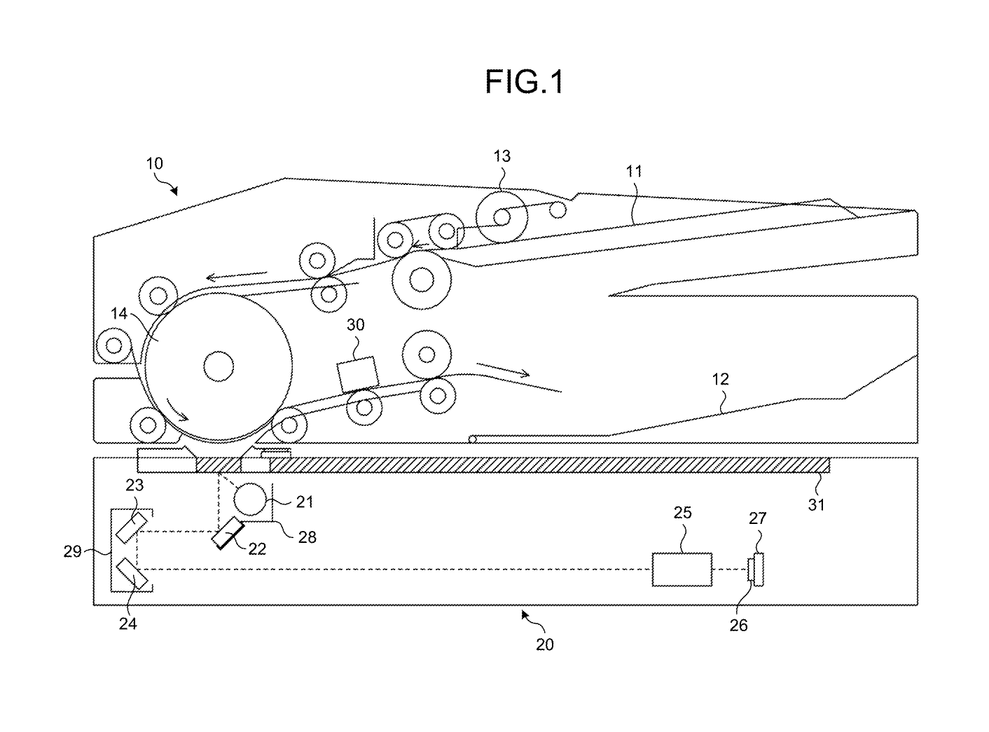

An image processing apparatus according to an embodiment of the present invention is an apparatus for performing image processing on a plurality of pieces of image data input from a plurality of scanning units. The image processing apparatus according to the embodiment can be mounted, for example, on an image forming apparatus including a plurality of scanning units. FIG. 1 is a diagram illustrating the hardware structure of such an image forming apparatus. FIG. 1 illustrates an image forming apparatus including an automatic document feeder 10 and an image reading device 20 provided under the automatic document feeder 10.

The automatic document feeder 10 includes a document tray 11 on which a document is placed; a discharge tray 12 onto which a scanned document is ejected; and a document feed mechanism such as a pick-up roller 13 and a carriage drum 14 that conveys the document from the document tray 11 to the discharge tray 12.

The image reading device 20 includes a light source 21 such as a lamp, reflecting mirrors 22 to 24 for guiding a reflected light of the light from the light source 21 to a certain direction, a lens 25 collecting the reflected lights from the reflecting mirror 24, a charge coupled device (CCD) 26 converting the light from the lens 25 into an electrical signal, a sensor circuit board 27 processing an electrical signal from the CCD 26, a first carriage 28 including the light source 21 and the reflecting mirror 22, a second carriage 29 including the reflecting mirrors 23 and 24, and a not-illustrated driving unit that drives the first carriage 28 and the second carriage 29. The image reading device 20 also includes a contact image sensor (CIS) 30 on the downstream in the sheet conveying direction of the carriage drum 14 in the automatic document feeder 10 and a transparent exposure glass 31.

To scan both sides of the document at the same time, scanning units are required on the positions above and below the exposure glass 31. Because there is not enough space for installing the CCD 26 in the position above the exposure glass 31, the compact CIS 30 capable of scanning images is provided here instead. It should be noted that the image forming apparatus may include a printing device for printing the scanned images of the document in addition to the automatic document feeder 10 and the image reading device 20.

The image reading device 20 includes two image reading sensors, so it has three scanning modes, for example. Users can select one of these modes using a not-illustrated operation panel and set the mode to the apparatus. The following three scanning modes are available, for example: a mode in which a document is placed on the exposure glass 31 and only one side of the document placed on the exposure glass 31 is scanned using the CCD 26; a mode in which while a document is automatically conveyed by the automatic document feeder 10 only one side of the document is scanned using the CCD 26; and a mode in which while a document is automatically conveyed by the automatic document feeder 10 and both sides of the document are scanned at the same time using the CCD 26 and the CIS 30.

When the image reading device 20 is set to the mode for scanning both sides of the document at the same time, the image reading device 20 conveys the document placed on the document tray 11 of the automatic document feeder 10 using the document feed mechanism, and scans the images on the front side and the back side of the document during the document conveyance at one time using the CCD 26 and the CIS 30. When the document passes through a position above the exposure glass 31, light from the light source 21 is reflected and the reflected light enters the CCD 26, through the reflecting mirrors 22 to 24 and the lens 25. Photoelectric conversion is then performed on the reflected light, thereby scanning images on one side of the document. The light source in the CIS 30 irradiates the document with light therefrom, and the reflected light from the document is collected by a SELFOC® lens array in the CIS 30 onto a light receiving sensor. Photoelectric conversion is then performed on the collected light, thereby scanning images on the other side of the document.

The scanned image data is converted by the sensor circuit board 27 from an analog signal into a digital signal, and then transmitted as digital data to a not-illustrated image processing apparatus.

The image forming apparatus is a multi function peripheral (MFP), for example, and may be a scanner or a copier. The image forming apparatus may include three or more scanning units rather than the above-described two scanning units, that is, the CCD 26 and the CIS 30. Furthermore, the scanning unit may have the same type of sensors rather than sensors of different types.

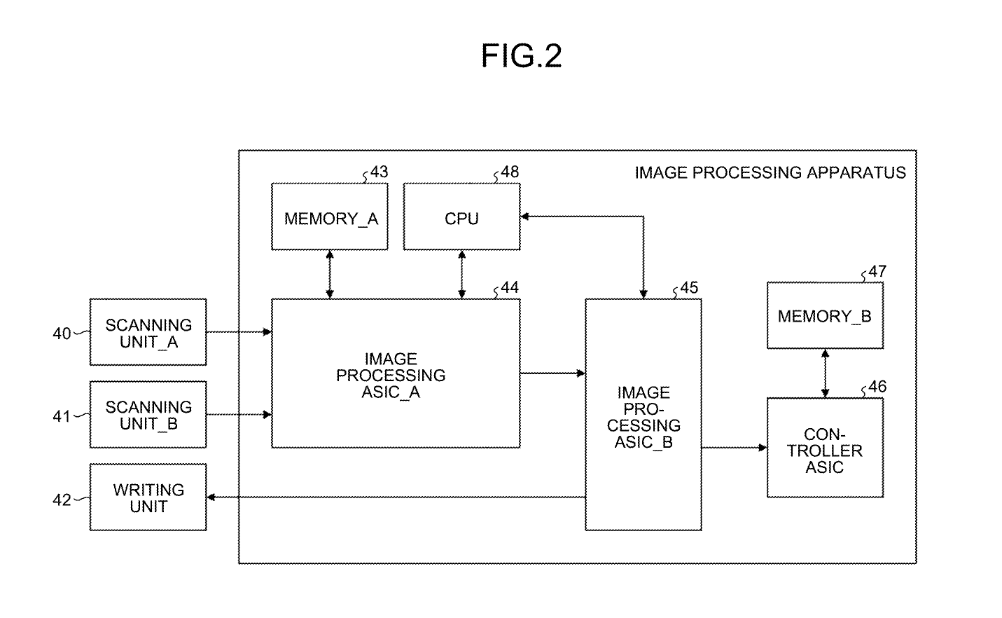

FIG. 2 is a diagram illustrating the hardware structure of the image processing apparatus according to the embodiment. FIG. 2 illustrates two scanning units and a writing unit 42 for a simplified description. The scanning units include a scanning unit_A 40 corresponding to the CCD 26, and a scanning unit_B 41 corresponding to the CIS 30. Three or more scanning units may be used instead of the two scanning units.

The scanning unit_A 40 is a scanning unit for scanning the front side of the document and corresponds to the CCD 26 illustrated in FIG. 1. The scanning unit_B 41 is a scanning unit for scanning the back side of the document and corresponds to the CIS 30 illustrated in FIG. 1. The writing unit 42 is a writing unit for optical writing by irradiating a not-illustrated photosensitive drum with a laser light to print the images on the front side and the back side of the document after image processing.

The image processing apparatus receives pieces of image data input from the two scanning units, that is, the scanning unit_A 40 and the scanning unit_B 41, performs image processing on the received image data using the parameters respectively set for the scanning unit_A 40 and the scanning unit_B 41, and outputs the processed image data to the writing unit 42. Hereinafter, “the image data” refers to front-side image data or back-side image data of the document, or to both of them.

For the image processing, a memory_A 43 is provided as an image data storage unit in the image processing apparatus for temporarily storing the image data input from the two scanning units, the scanning unit_A 40 and the scanning unit_B 41. The memory_A 43 serves as a buffer provided for absorbing the speed difference between the scanning speed at which image data is scanned with scanning unit_A 40 and the scanning unit_B 41 and is input to the image processing apparatus, and the transfer speed at which the image data is transferred within the image processing apparatus for the image processing.

The image processing apparatus includes an image processing application specific integrated circuit (ASIC)_A 44 as a reading unit for reading image data from the memory_A 43 and an image processing unit. The image processing ASIC_A 44 has a function to read out the front-side image data and the back-side image data in this order, or in the reverse order and transfers the image data in serial. The image processing ASIC_A 44 performs image processing such as shading correction and gamma correction, for example.

The shading correction is processing for correcting unevenness of the brightness of images due to the characteristics of the optical system or the image capturing system and making the images have uniform brightness. The gamma correction is processing for correcting fluctuation of the chromogenic property depending on apparatuses and making the images maintain the original brightness.

The image processing apparatus includes an image processing ASIC_B 45 as an image processing unit that receives the image data transferred from the image processing ASIC_A 44 and performs other image processing on the received image data. The image processing ASIC_B 45 transfers the image data after being processed to a controller ASIC 46 and receives the image data processed by the controller ASIC 46. The image processing ASIC_B 45 then performs tone processing on the image data for changing the number of tone steps quantified with the number of steps of color gradations, and transfers the processed image data to the writing unit 42.

The controller ASIC 46 performs compression, extension, editing, and other processing on image data using the memory_B 47. The CPU 48 executes software to control the scanning unit_A 40 and the scanning unit_B 41, the image processing ASIC_A 44, and the image processing ASIC_B 45. The image processing apparatus also includes not-illustrated two registers as parameter storage units for storing therein the parameters. The registers stores therein the parameters respectively set for the scanning unit_A 40 and the scanning unit_B 41. That is to say, one of the registers stores therein only the parameter(s) set for processing the images scanned by the scanning unit_A 40, and the other register stores therein only the parameter(s) set for processing the images scanned by the scanning unit_B 41.

The image processing apparatus is capable of performing image processing such as noise reduction for removing noise in images, magnification and reduction, binarization, value multiplexing, dithering, edge detection, and color space conversion of images. Such processing can be performed by the image processing ASIC_A 44 or the image processing ASIC_B 45.

Parameters stored in the registers are, for example, the color/monochrome setting, the image size, the ratio of magnification or reduction, and the resolution of images that are made by a user before scanning images, and a reading value of the reference white board used for the shading correction, a gamma value used for the gamma correction, a factor in a smoothing filter or a Laplacian filter used for the noise reduction, and a threshold in binarization. The parameters are not limited to these examples.

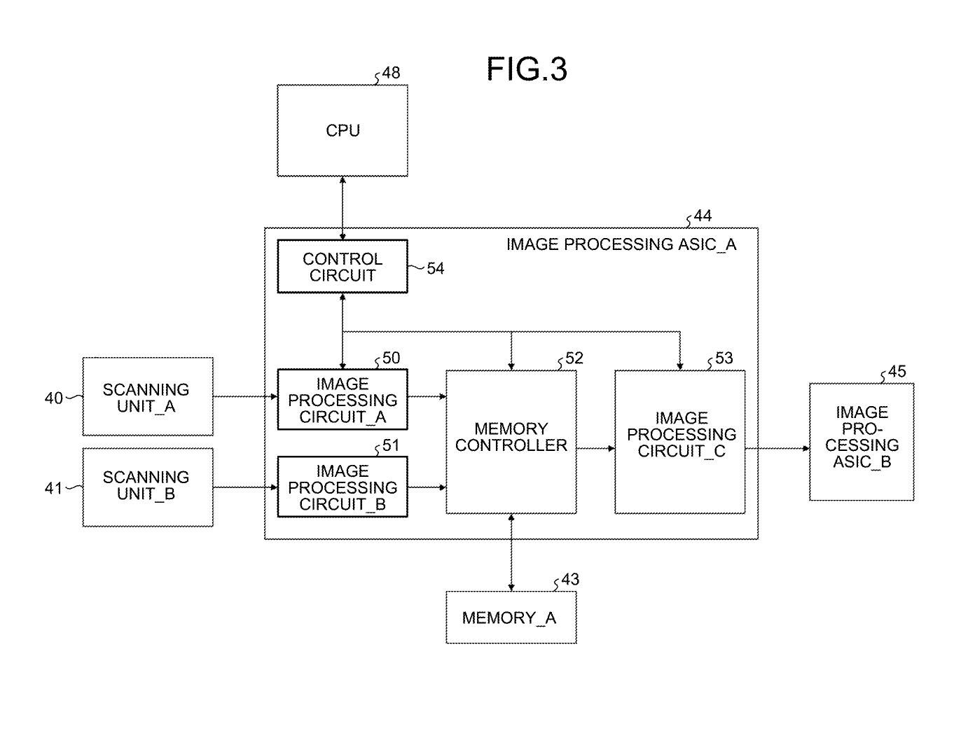

FIG. 3 is a diagram illustrating the hardware structure of the image processing ASIC_A 44. The scanning unit_A 40 scans the front side of the document and inputs the scanned image as front-side image data to an image processing circuit_A 50. The scanning unit_B 41 scans the back side of the document and inputs the scanned image as back-side image data to an image processing circuit_B 51. The scanning unit_A 40 and the scanning unit_B 41 each include a register for storing therein the parameters set for the corresponding scanning unit.

The parameters are set to the registers before the software is executed by the CPU 48 to start reading the first piece of image data from the memory_A 43. The parameters are set only once per document at the beginning of processing. The above-described software can be registered in a storage device such as a separately provided hard disk drive (HDD) and read by the CPU 48 for execution.

The image processing circuit_A 50 and the image processing circuit_B 51 perform image processing such as shading correction on the front-side image data and the back-side image data, respectively, using the parameters stored in the corresponding registers, and transmit the processed image data to the memory controller 52.

The memory controller 52 stores the front-side image data in the memory_A 43 immediately after receiving it from the image processing circuit_A 50, and stores the back-side image data in the memory_A 43 immediately after receiving it from the image processing circuit_B 51. Subsequently, the memory controller 52 receives a signal for specifying the order of reading image data from the control circuit 54 (an order designation signal). The memory controller 52 reads the image data from the memory_A 43 according to the order specified by the order designation signal. The order designation signal is not limited to specifying the order of reading the image data from the front-side image data to the back-side image data. The order designation signal may specify the order of reading the image data from the front-side image data, the back-side image data, then the back-side image data, to the front-side image data, and so on, for example. The memory controller 52 reads the image data from the memory_A 43 in the order from the front-side image data to the back-side image data specified by the order designation signal, and transfers the read image data to an image processing circuit_C 53.

The image processing circuit_C 53 receives a signal for designating the register (a register designation signal) from the control circuit 54 and performs image processing on the image data using the parameters stored in the register designated by the register designation signal. For example, the image processing circuit_C 53 performs the gamma correction using the gamma value that has been set in the register. The gamma correction can be performed with look-up table (LUT) conversion. The image processing circuit_C 53 transfers the processed image data to the image processing ASIC_B 45 for executing other image processing.

The control circuit 54 controls the image processing circuit_A 50, the memory controller 52, and the image processing circuit_C 53 in response to instructions from the CPU 48. The control circuit 54 generates the above-described order designation signal to be supplied to the memory controller 52 in response to the image processing circuit_A 50 having transferred the front-side image data to the memory controller 52. Subsequently, the control circuit 54 supplies the generated signal to the memory controller 52. The control circuit 54 generates the register designation signal to be supplied to the image processing circuit_C 53 in response to the memory controller 52 having started reading the back-side image data. Subsequently, the control circuit 54 supplies the generated register designation signal to the image processing circuit_C 53. As described above, the control circuit 54 functions as a signal generator for generating these signals.

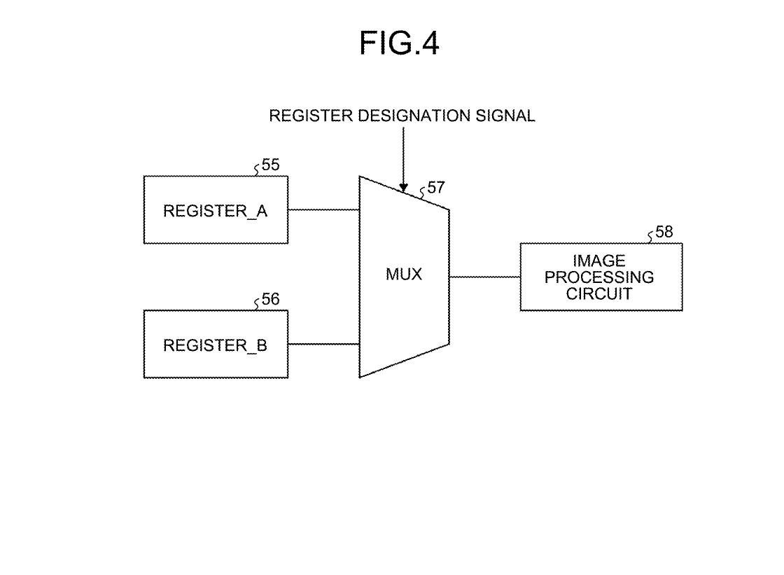

The parameters are input, as illustrated in FIG. 4, from the register_A 55 and the register_B 56 to the multiplexer (MUX) 57, then the register to be used is determined based on the register designation signal so that the image processing circuit 58 performs image processing using the parameters in the determined register.

That is, the image processing circuit_C 53 includes the MUX 57 that receives the register designation signal based on which the register to be used can be selected. The image processing circuit_C 53 can transmit the register designation signal together with the processed image data to the image processing ASIC_B 45. The image processing ASIC_B 45 may also include the MUX 57 so that the register to be used can be selected based on the register designation signal. The MUX 57 may be arranged between the image processing circuit_C 53 and the two registers rather than in the image processing circuit_C 53.

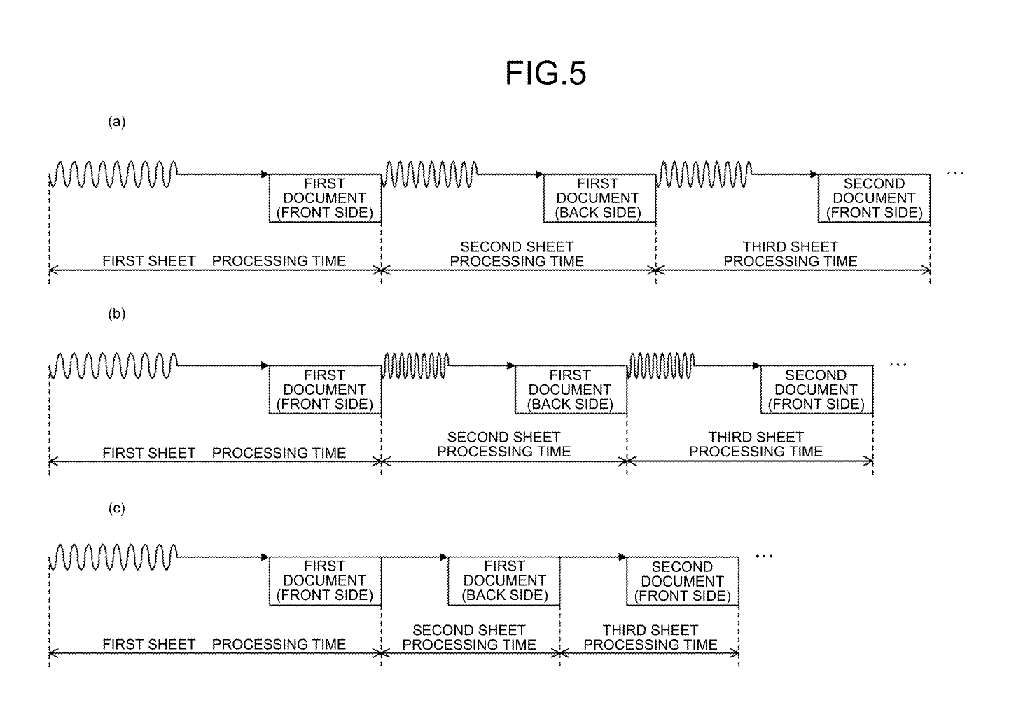

With reference to FIG. 5, the following describes image processing time required when the parameters are set every time image processing is performed using software in the conventional method, and image processing time required when the register is selected when the image processing is performed using the hardware (ASIC) based on the signal for specifying the register (in a hardware manner) according to the embodiment. FIG. 5 is a diagram illustrating the difference between the processing time required when parameters are set in a software manner and the processing time required when parameters are set in a hardware manner.

Section (a) in FIG. 5 illustrates the relation between the processing in the conventional method and its processing time. Section (b) in FIG. 5 illustrates the relation between the processing in a method in which a part of the processing is performed in a hardware manner and its processing time. Section (c) in FIG. 5 illustrates the relation between the processing in a method in which the entire processing is performed in a hardware manner and its processing time. The wavy lines illustrated in sections (a) to (c) in FIG. 5 represent the period during which the CPU 48 executes the software to set the parameters for controlling the image processing ASIC_A 44, for example. The solid lines represent the period during which the CPU 48 executes other processing such as controlling the image processing ASIC_B 45. The texts such as “First Document (Front Side)” and “First Document (Back Side)” each illustrated in a rectangular shape represent which side of which document is being processed.

The processing time until processing on the front side of the first document ends is equal among all the methods illustrated in FIG. 5, as represented with the equal length of the wavy lines and solid lines. This is because in all of the methods, the parameters are set on the register by the software executed by the CPU 48, the setting requires an equal time, whereby the other processing described above also requires an equal time in all of the methods.

The processing time until processing on the back side of a first document ends in the conventional method requires a certain length of setting time because the parameters need to be set every time image processing is performed. By contrast, in the method in which a part of the processing is performed in a hardware manner, only some of the parameters need to be set, thereby reducing the setting time. In the method in which the entire processing is performed in a hardware manner, no parameters need to be set and no setting time is required, thereby significantly reducing the processing time.

After that, the processing is performed in the same manner as the above-described processing on the back side of the first document. As a result, processing in a hardware manner can reduce or remove the time required for setting the parameters, thereby reducing the time required for the image processing, and improving the productivity in the image processing.

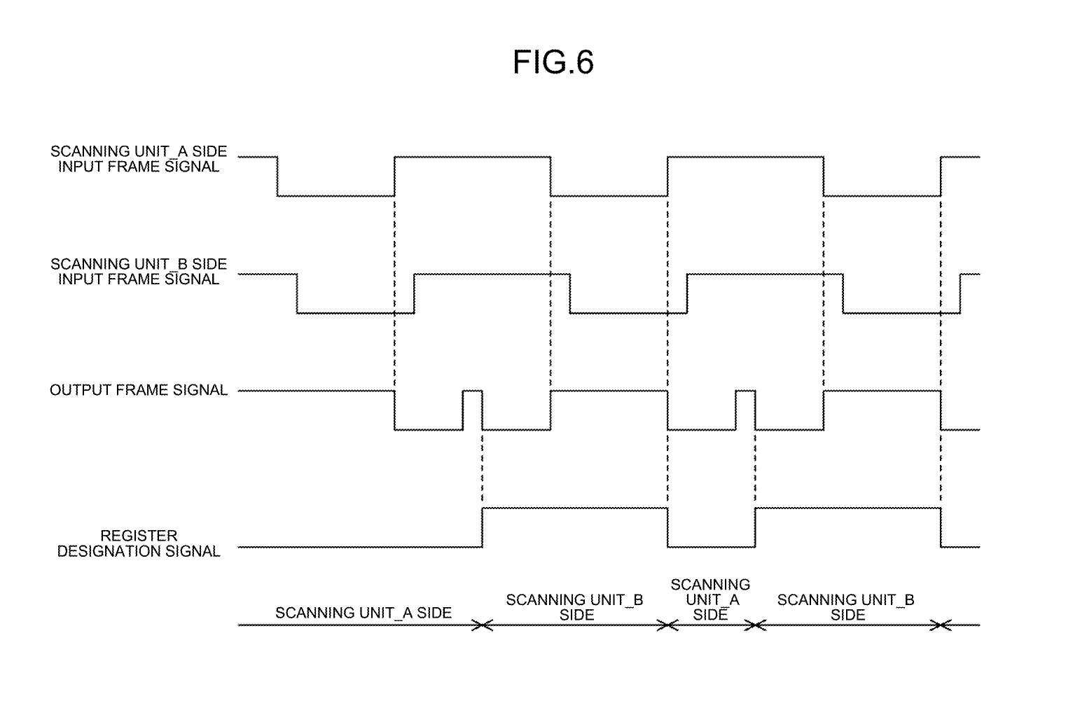

The description above is about an example that the memory controller 52 executes the reading of image data in synchronization with an output frame signal, and the image processing circuit_C 53 accesses the register specified by the register designation signal and performs image processing using the parameters stored in the register, whereby the processing is achieved in a hardware manner. Certain signals are used for achieving the processing in a hardware manner. The input timing of the signals will now be described in detail with reference to FIGS. 6 to 10.

The CPU 48 controls the automatic document feeder 10, the scanning unit_A 40 and the scanning unit_B 41 to read a plurality of document sheets one by one at constant time intervals. The image reading device 20 is structured so that the scanning unit_A 40 scans the front side of a document sheet and the scanning unit_B 41 scans the back side of the document sheet. The scanning unit_B 41 is arranged on the downstream in the sheet conveying direction of the scanning unit_B 40, therefore, the start time and the end time for scanning of the scanning unit_B 41 is later than that of the scanning unit_A 40.

FIG. 6 is a diagram illustrating the input timing of the signals according to a first example. The pieces of image data from the scanning unit_A 40 and the scanning unit_B 41 are input to the image processing ASIC_A 44 in synchronization with their respective input frame signal (low active signals). The input frame signals are input from the scanning unit_A 40 and the scanning unit_B 41, respectively. The input image data is temporarily stored as the front-side image data and the back-side image data in the memory_A 43. An low active signal here refers to a signal indicating “1” when a voltage is low and indicating “0” when a voltage is high.

As illustrated in FIG. 6, the input frame signal on the scanning unit_A side indicates “1” until the input of the front-side image data from the scanning unit_A 40 is started. When the input is started, the signal falls from 1 to 0. While the front-side image data is being input, the input frame signal indicates 0. After the input ends, the input frame signal rises from 0 to 1. This also applies to the input frame signal on the scanning unit_B side.

The rise of the input frame signal on the scanning unit_A side represents that the front-side image data has been stored in the memory_A 43, and the stored front-side image data can be read from the memory_A 43. Therefore, the rise of the input frame signal on the scanning unit_A side triggers the memory controller 52 to start reading the front-side image data stored in the memory_A 43.

The memory controller 52 reads the image data in synchronization with the output frame signal (a low active signal). When the input frame signal on the scanning unit_A side rises, the output frame signal falls from 1 to 0, whereby reading by the memory controller 52 is achieved because the memory controller 52 starts reading from the memory_A 43 triggered by the fall of the output frame signal. Therefore, the control circuit 54 generates a signal in which the signal falls from 1 to 0 in response to the rise of the input frame signal, and input the generated signal to the memory controller 52. Actually, the control circuit 54 generates a signal indicating 0 or 1 and inputs the generated signal, whereby the rise or fall of the signal is achieved. For simple description, hereinafter the following expressions are used such as “the control circuit 54 controls the signal to rise” and “the control circuit 54 controls the signal to fall”.

The register including the parameters used for image processing is selected as follows. The register storing the parameters for the front side is specified by the register designation signal because the front-side image data is read and processed at first. Specifically, the control circuit 54 generates a register designation signal indicating 0 that represents the register including the parameters for the front side, and inputs the register designation signal indicating 0 to the image processing circuit_C 53. The image processing circuit_C 53 accesses the register storing the parameters for the front side in response to the register designation signal indicating 0, thereby processing the image data using the parameters for the front side.

When the reading, transferring, and image processing of the front-side image data end, the output frame signal is controlled by the control circuit 54 to rise from 0 to 1. After a given time elapses, the control circuit 54 controls the output frame signal to fall from 1 to 0, and then the memory controller 52 starts reading the back-side image data from the memory_A 43 in synchronization with the output frame signal. The output frame signal specifies that the back-side image data is read after the front-side image data, thus serving as the order designation signal described above.

When the reading of the back-side image data is started, the back-side image data is transferred to the image processing circuit_C 53. The image processing circuit_C 53 needs to access the register to use the parameters for the back side stored therein. The control circuit 54 therefore controls the register designation signal to rise from 0 to 1 at the timing of the fall of the output frame signal. This enables the image processing circuit_C 53 to access the register including the parameters for the back side in response to the register designation signal indicating 1.

As described above, the output frame signal and the register designation signal can be used for reading image data from the memory_A 43 and switching registers to be accessed automatically in the image processing ASIC_A 44. This eliminates the necessity of selecting and setting parameters by the software executed by the CPU, thereby reducing a time required for the image processing, and improving the productivity in the image processing.

When the reading, transferring, and image processing of the back-side image data end, the output frame signal is controlled by the control circuit 54 to rise from 0 to 1. The rise of the output frame signal triggers input of image data of a second sheet of document. At this time, the register designation signal indicates 1 for using the parameters for the back side. The register designation signal needs to be changed to 0 for processing the front-side image data.

The register designation signal can be controlled to fall from 1 to 0 triggered by the rise of the input frame signal on the scanning unit_A side or the fall of the output frame signal. As a result, switching can be achieved to access the register storing the parameters for the front side. The subsequent timing of the rise and fall of the signal is the same as described above until there is no document to be scanned.

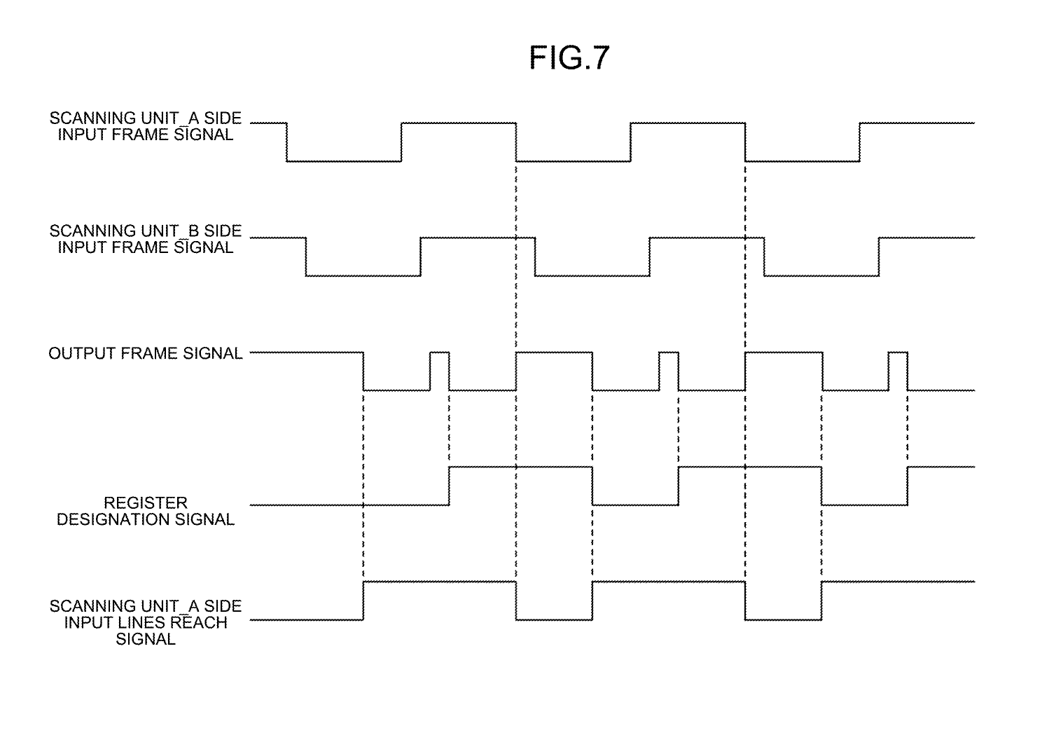

FIG. 7 is a diagram illustrating the input timing of the signals according to a second example. In the second example, the timing of reading image data from the memory_A 43 is accelerated, thereby reducing the processing time. In the example illustrated in FIG. 7, to accelerate the timing of reading image data, an input lines reach signal is provided. The input lines reach signal indicates that the number of lines of the image data input from the scanning unit_A 40 reaches a predetermined number of lines. Reading the image data is started by the input lines reach signal in the second example. The input lines reach signal can be generated by the control circuit 54 based on the number of the lines input to the image processing circuit_A 50. For example, the control circuit 54 receives information on the input number of lines generated by the image processing circuit_A 50 and generates the input lines reach signal based on the information.

More specifically, an image in image data includes a plurality of lines in which pixels line up. When the number of lines of the input data reaches a predetermined number of lines, the input lines reach signal is controlled by the control circuit 54 to rise from 0 to 1. The rise of the input lines reach signal triggers the control circuit 54 to control the output frame signal to fall from 1 to 0, and then the memory controller 52 starts reading the front-side image data in synchronization with the output frame signal.

For the input of images on the front side of a second document sheet, the input lines reach signal needs to rise from 0 to 1 when the number of lines of the input data reaches the predetermined number of lines again. The input lines reach signal therefore needs to fall from 1 to 0 beforehand. For example, as illustrated in FIG. 7, the reading, transferring, and image processing of the back-side image data of a first document by the memory controller 52 end, and the rise of the output frame signal triggers the input lines reach signal to fall. The embodiment is not limited to this example, however. For example, after the reading and transferring of the front-side image data of the first document end, the rise of the output frame signal or the subsequent fall of the output frame signal for starting reading the back-side image data, may trigger the input lines reach signal to fall.

As described above, in the second example, by starting reading the image data stored in the memory_A 43 before the input of the front-side image data ends, the waiting time before the processing can be reduced. In addition, an unnecessary processing time for controlling by the CPU 48, for example, can be eliminated, thereby improving the productivity in the image processing.

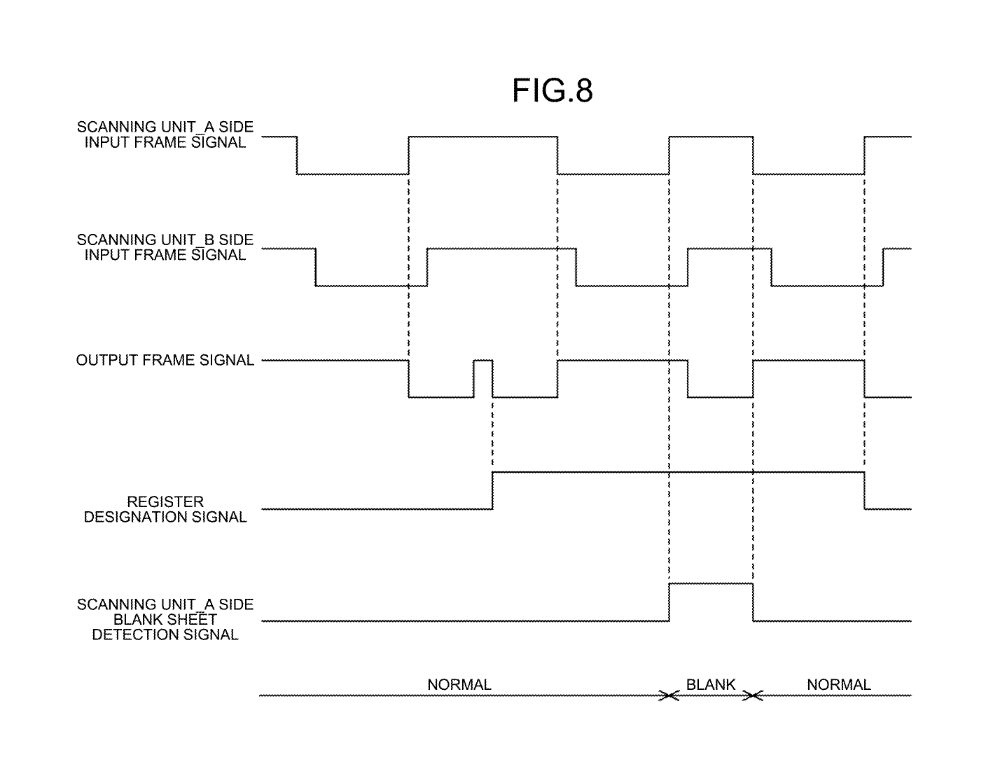

FIG. 8 is a diagram illustrating the input timing of the signals according to a third example. In the third example, image processing is cancelled when the image data does not include a predetermined amount of image information (letters, pictures, or photographs), i.e., the document sheet is a blank sheet, thereby reducing the processing time. In the example illustrated in FIG. 8, a blank sheet detection signal is provided that indicates whether the document sheet is a blank sheet. The blank sheet detection signal can be generated by the control circuit 54. The memory controller 52 can start or cancel reading image data from the memory_A 43 based on the blank sheet detection signal. The control circuit 54 receives information whether the document sheet is a blank sheet, which has been generated by the image processing circuit_A 50 and the image processing circuit_B 51 based on the input image data, and generates the blank sheet detection signal based on the information.

The blank sheet detection signal is determined as an high active signal indicating “1” when a voltage is high and indicating “0” when a voltage is low. In the example illustrated in FIG. 8, no image exists on the scanned front side of a second document sheet, and the document sheet is determined to be a blank sheet. As a result, the control circuit 54 generates and outputs a blank sheet detection signal to control the memory controller 52 to cancel the reading of the front-side image data of the second document sheet.

The blank sheet can be detected as follows, for example. Pixel values of all pixels in the image of the document sheet are checked and the total of the pixel values is determined whether it reaches a certain value that can be set as a threshold. This is only an example and any other known method can be used as long as it can detect a blank sheet.

In the example illustrated in FIG. 8, the front-side image data of the second document sheet does not include a predetermined amount of image information, so it is detected that the document sheet is a blank sheet. As a result, at the time point when the input of the front-side image data, which is input in synchronization with the input frame signal on the scanning unit_A side, ends, the control circuit 54 controls the blank sheet detection signal to rise from 0 to 1. The memory controller 52 detects that the blank sheet detection signal indicates 1 and thus cancels the reading of the front-side image data.

After the memory controller 52 cancels the reading of the front-side image data and a given time elapses, the output frame signal is controlled by the control circuit 54 to fall from 1 to 0 so that the memory controller 52 starts reading the subsequent back-side image data of the second document sheet. At the time point when the reading, transferring, and image processing of the back-side image data of the second document sheet end, the output frame signal is controlled to rise from 0 to 1 and this triggers the blank sheet detection signal to fall from 1 to 0. The rise of the output frame signal serves as the trigger here, however, the prior fall of the output frame signal may serve as the trigger.

In the processing on the third and subsequent document sheets, if it is detected again that the document sheet is a blank sheet, the blank sheet detection signal is controlled to rise from 0 to 1 and the memory controller 52 accordingly cancels the reading of the front-side image data of the document sheet as described above. In this example, the detection of the blank sheet is performed on the front-side image data only, however, the detection of the blank sheet can also be performed on the back-side image data in the same manner. If the detection of the blank sheet is also performed on the back-side image data, a blank sheet detection signal for the scanning unit_B side may be separately provided.

The blank sheet detection is performed typically using the image data stored from the controller ASIC 46 to the memory_B 47 illustrated in FIG. 2, and the reading and transferring of the images need to be performed in the image processing ASIC_A 44. In the example, however, the reading of images in the image processing ASIC_A 44 is cancelled, thereby improving the productivity in the image processing.

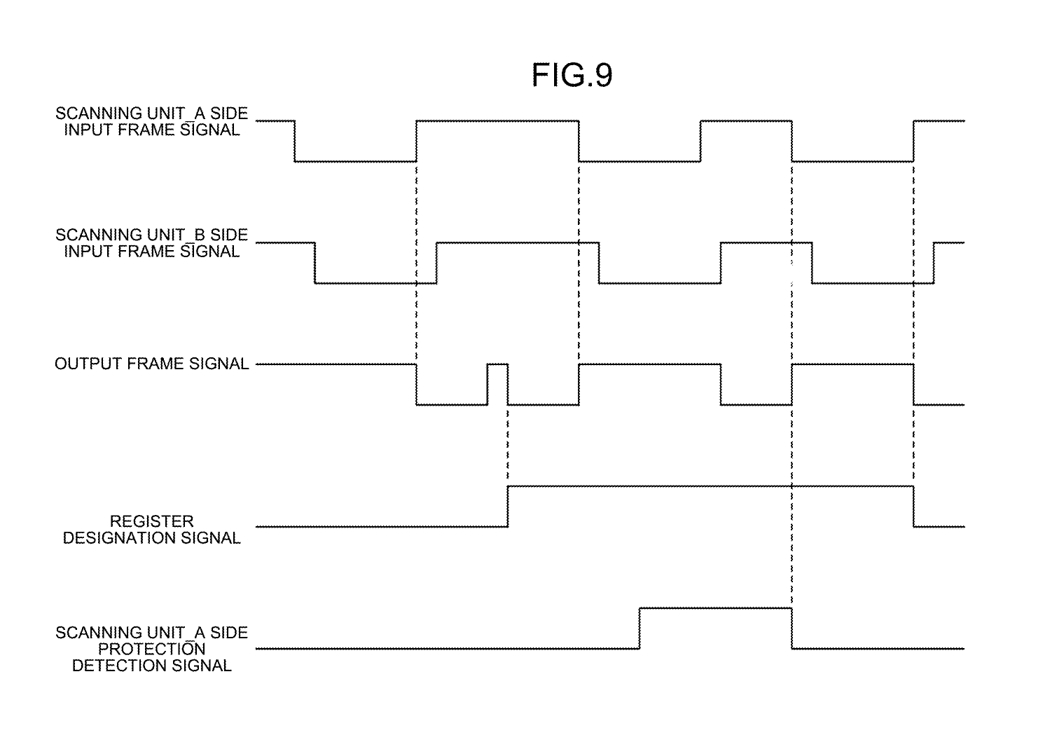

FIG. 9 is a diagram illustrating the input timing of the signals according to a fourth example. In the fourth example, image processing is cancelled when the read image data includes data protection information for protecting data, thereby reducing the processing time. In the example illustrated in FIG. 9, a protection detection signal is provided that indicates whether the data protection information is included. The protection detection signal can also be generated by the control circuit 54. The memory controller 52 can start or cancel reading image data from the memory_A 43 based on the protection detection signal. The control circuit 54 receives information whether data protection information is included, which has been generated by the image processing circuit_A 50 and the image processing circuit_B 51 based on the input image data, and generates the protection detection signal based on the information.

In the example illustrated in FIG. 8, it is detected whether the document sheet is a blank sheet. In the example illustrated in FIG. 9, it is detected whether images on the document include data protection information such as copy inhibition information. A protection detection signal is output based on the detection result. The protection detection signal is a high active signal, that is, refers to a signal indicating “1” when a voltage is high and indicating “0” when a voltage is low.

The data protection information is a background pattern or a dedicated code, for example. The data protection information can be detected by detecting presence of such a background pattern or a dedicated code, for example.

In the example illustrated in FIG. 9, when it is detected that images on the front side of a second document sheet include data protection information, the control circuit 54 controls the protection detection signal to rise from 0 to 1. Typically, when the input of the front-side image data of the second document sheet ends, the rise of the input frame signal triggers the output frame signal to fall from 1 to 0, and reading of the front-side image data is started. If the protection detection signal “1” is detected, the memory controller 52 cancels the writing of the front-side image data to the memory_A 43.

After the memory controller 52 cancels the writing of the front-side image data and a given time elapses, the output frame signal is controlled by the control circuit 54 to fall from 1 to 0 so that the memory controller 52 starts reading the subsequent back-side image data of the second document sheet. At the time point when the reading, transferring, and image processing of the back-side image data of the second document sheet end, the output frame signal is controlled to rise from 0 to 1 and this triggers the protection detection signal to fall from 1 to 0. The rise of the output frame signal serves as the trigger here, however, the prior fall of the output frame signal may serve as the trigger.

After that, if it is detected again that the images on the document include the data protection information, the protection detection signal is controlled to rise from 0 to 1 and the memory controller 52 accordingly cancels the writing of the front-side image data of the document as described above. In this example, the detection of the data protection information is performed on the front-side image data, however, the detection of the data protection information can also be performed on the back-side image data in the same manner. If the detection of the data protection information is performed on the back-side image data, a protection detection signal for the scanning unit_B side may be separately provided.

In the example, writing to the memory_A 43 is cancelled when the data protection information is detected, whereby the power consumption for accessing the memory can be suppressed. This achieves reduction of energy consumption in addition to the above-described improvement of the productivity.

Meanwhile, when a plurality of document sheets are set on the apparatus, some of the document sheets may be placed upside down. If the reading of document sheets that are upside down is started in this state, the document sheets are output in the wrong page order and need to be sorted in the correct order. If the document has a large number of pages, it takes a long time to find out which pages are upside down. This makes the processing time longer, thereby reducing the productivity.

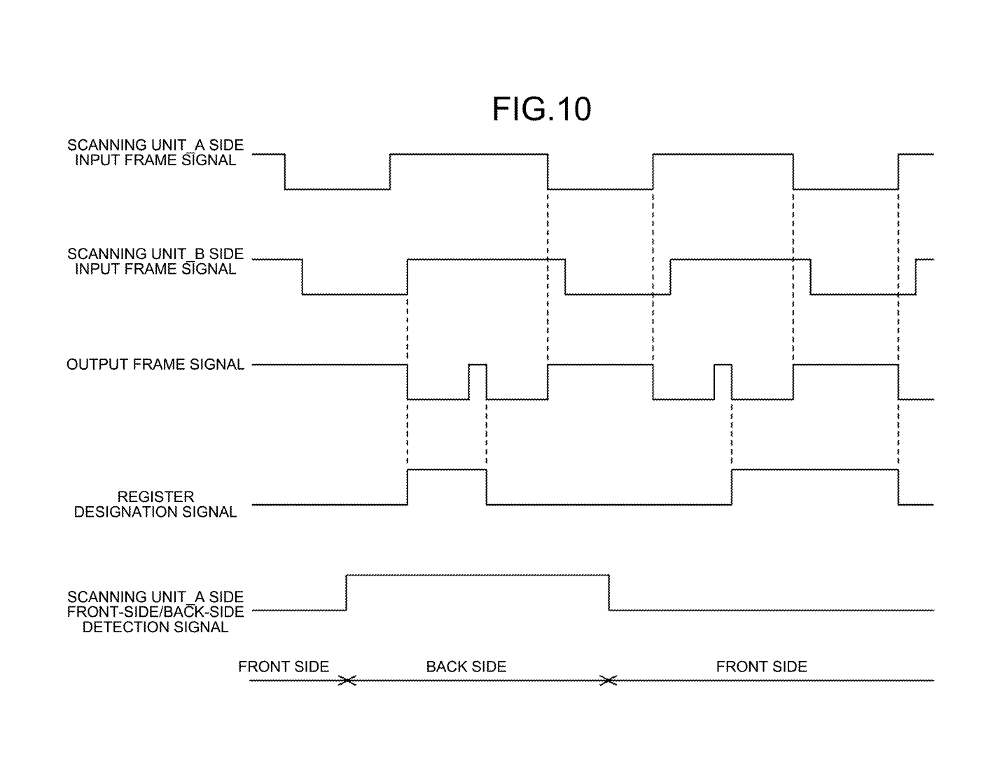

FIG. 10 is a diagram illustrating the input timing of the signals according to a fifth example. In the fifth example, it is determined whether the scanned image data is the front-side image data or the back-side image data. If it is determined that the scanned image data is the back-side image, the order of the image processing is reversed to perform the image processing in the correct order. In the example illustrated in FIG. 10, a front-side/back-side detection signal is provided that indicates whether the scanned image data is the front-side image data or the back-side image data. The front-side/back-side detection signal can also be generated by the control circuit 54. The memory controller 52 can perform the reading of the front-side image data and the back-side image data in this order from the memory_A 43 based on the front-side/back-side detection signal.

In the example illustrated in FIG. 10, image data on a first document is input in the order from the back side to the front side. When the control circuit 54 detects that the image data is the back-side image data based on the input image data received by the image processing circuit_A 50, the control circuit 54 controls the front-side/back-side detection signal to rise from 0 to 1. When the front-side/back-side detection signal indicates 0, the image data is the front-side image data, while when the front-side/back-side detection signal indicates 1, the image data is the back-side image data.

When the memory controller 52 refers to the front-side/back-side detection signal and detects that it indicates 1, the memory controller 52 firstly reads the image data input from the scanning unit_B side out of the image data stored in the memory_A 43 as the front-side image data. After that, the memory controller 52 reads the remaining image data as the back-side image data. As a result, pieces of the document sheet data are rearranged in the correct order without using a specific unit for sorting the document sheets.

The front side and the back side can be detected using the page numbers printed on each page, for example. A smaller page number is printed on the front side and the subsequent page number is printed on the back side typically. For another example, the front side and the back side can be determined by detecting the presence of a specific numeral, letter, or symbol provided on the front side or the back side only.

In the example illustrated in FIG. 10, the first document sheet is upside down. The output frame signal therefore falls from 1 to 0 triggered by the rise of the input frame signal on the scanning unit_B side. This makes the memory controller 52 to start reading the image data. The register designation signal rises from 0 to 1 triggered by the rise of the input frame signal on the scanning unit_B side or the fall of the output frame signal, thereby specifying the register including the parameters for the back side. This is because the image data firstly read is the image data scanned by the scanning unit_B 41 that scans the back side of a document.

When the reading, transferring, and image processing of the front-side image data end, the output frame signal is controlled by the control circuit 54 to rise from 0 to 1. After a given time elapses, the output frame signal is controlled by the control circuit 54 to fall from 1 to 0. The memory controller 52 starts reading the back-side image data from the memory_A 43 in synchronization with the fall of the output frame signal. The register designation signal is controlled by the control circuit 54 to fall from 1 to 0 triggered by the rise or fall of the output frame signal, thereby specifying the register including the parameters for the front side.

The front-side/back-side detection signal is controlled to remain “1” indicating that the back side is detected and controlled to fall from 1 to 0 in response to the order where the order is corrected from the front side to the back side. If it is detected again that the document sheet is upside down, the front-side/back-side detection signal is controlled to rise from 0 to 1. As described above, image data can be read while the pieces of image data are sorted in the originally intended order, that is, from the front side to the back side.

This achieves a page sort function without controlling by the CPU 48, for example. Therefore, additional time is not required for the image processing, thereby improving the productivity in the image processing.

In the example illustrated in FIG. 10, the detection is performed only whether the image data is the front-side image data or the back-side image data and replacing them as necessary. However, if a second document sheet and a third document sheet are placed in the reversed order, the document sheets can also be sorted in the correct order, using data identification information for identifying the image data itself by the above-described page numbers.

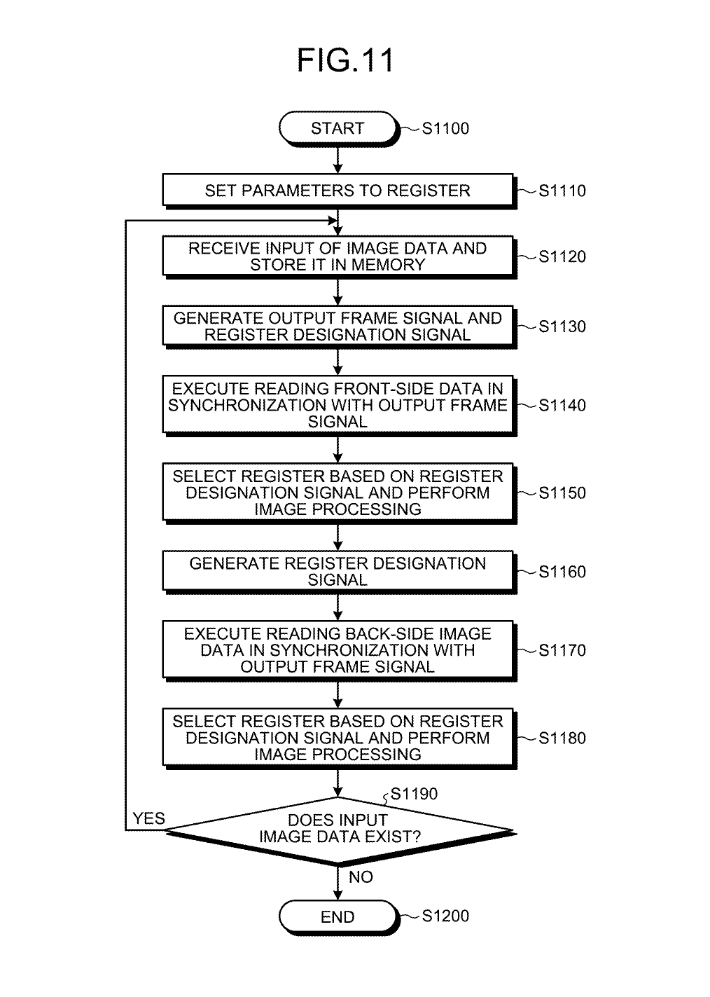

The present invention can provide an image processing apparatus as described above and an image forming apparatus including the image processing apparatus. Furthermore, the present invention can provide an image processing method executed by the image processing apparatus. An example of the image processing method is described in short with reference to the flowchart illustrated in FIG. 11.

The image processing method starts from Step S1100. At Step S1110, the CPU 48 executes software to set the parameters for the front side and the parameters for the back side on the respective registers. At Step S1120, the image processing circuit_A 50 receives the input of the front-side image data and the image processing circuit_B 51 receives the input of the back-side image data, then they perform image processing such as shading correction on the received data and store the data in the memory_A 43.

At Step S1130, the control circuit 54 generates the output frame signal and the register designation signal and provides them to the memory controller 52 and the image processing circuit_C 53. The output frame signal is controlled to fall triggered by the rise of the input frame signal on the scanning unit_A side. At Step S1140, the memory controller 52 executes the reading of the front-side image data in synchronization with the output frame signal. At Step S1150, the memory controller 52 transfers the read image data to the image processing circuit_C 53. The image processing circuit_C 53 selects a register based on the register designation signal and performs image processing using the parameters for the front side set in the selected register.

At the time point when the image processing ends, the output frame signal is controlled to rise from 0 to 1. After a given time elapses, the output frame signal is controlled to fall from 1 to 0 for reading the back-side image data. At Step S1160, the control circuit 54 generates the register designation signal. That is to say, the control circuit 54 controls the register designation signal to rise from 0 to 1 triggered by the fall of the output frame signal. At Step S1170, the memory controller 52 executes the reading of the back-side image data in synchronization with the output frame signal. At Step S1180, the memory controller 52 transfers the read image data to the image processing circuit_C 53. The image processing circuit_C 53 performs the image processing using the parameters for the back side set in the specified register based on the register designation signal.

At Step S1190, it is determined whether a document sheet to be scanned exists. If a document sheet to be scanned exists, the processing is returned to Step S1120 and if no document sheet to be scanned exists, the processing is proceeded to Step S1200 and ended. At Step S1120, at the time point when the image processing on the back-side image data ends, the output frame signal is controlled to rise from 0 to 1. This triggers the input of image data of the subsequent document sheet.

The image processing method may include, for example, determining whether the number of lines of the input image data reaches a predetermined number of lines described above and the reading of the image data from the memory_A 43 if it is determined that the number of lines of the input image data reaches the predetermined number of lines, and determining whether the image data includes a predetermined amount of image information and cancelling the reading of the image data if it is determined that the image data does not include the predetermined amount of image information, as described above. The image processing method may also include determining whether the image data includes data protection information and cancelling the writing of the image data to the memory_A 43 if it is determined that the image data includes the data protection information, and determining whether the image data is the front-side image data or the back-side image data, correcting the order to read the image data from the memory_A 43 if the front-side image data or the back-side image data are in the reverse order, i.e., the document sheet is upside down.

In the description above, the image processing apparatus is mounted on the image forming apparatus, however, the present invention is not limited to this example. The image processing apparatus may be achieved with a computer or a tablet terminal, for example, and coupled to an image forming apparatus including a plurality of scanning units though a communication cable or through a network.

According to the present invention, the necessity of selecting and setting parameters by software is eliminated and the processing time is significantly reduced. This improves the productivity in image processing.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus comprising:
an image data storage unit that stores therein a plurality of pieces of image data input from a plurality of scanning units;
a plurality of parameter storage units that are provided respectively corresponding to the scanning units and store therein parameters respectively set for the scanning units;
a signal generator configured to generate a signal for specifying an order of reading the image data from the image data storage unit and for specifying one of the parameter storage units that stores therein the parameter to be used for the read image data;
a reading unit that reads the image data in the order specified by the signal; and
an image processing unit configured to perform image processing on the read image data using the parameters stored in the parameter storage unit specified by the signal.

2. The image processing apparatus according to claim 1, wherein the reading unit starts reading the image data from the image data storage unit in response to end of input of a frame signal, the frame signal being input in synchronization with input of the image data from the scanning unit.

3. The image processing apparatus according to claim 1, wherein
an image in the image data include a plurality of lines and
the reading unit starts reading the image data from the image data storage unit when the number of lines of the image data input from the scanning unit reaches a predetermined number of lines.

4. The image processing apparatus according to claim 1, wherein the reading unit cancels reading of the image data from the image data storage unit when the image data does not include a predetermined amount of image information.

5. The image processing apparatus according to claim 1, further comprising a writing unit that writes and stores the input image data in the image data storage unit, wherein
the writing unit cancels writing of the image data in the image data storage unit when the image data includes data protection information for protecting data.

6. The image processing apparatus according to claim 1, wherein
the pieces of image data are image data on front and back sides of a document,
the order is from the front side to the back side, and
in a case where the image data is input in the order from the back side to the front side, the reading unit reads the image data from the image data storage unit in reverse order.

7. An image forming apparatus comprising:
an image reading device that includes a plurality of scanning units; and
the image processing apparatus according to claim 1.

8. An image processing method executed by an image processing apparatus that includes a image data storage unit that stores therein a plurality of pieces of image data input from a plurality of scanning units; a plurality of parameter storage units that are respectively provided corresponding to the scanning units and store therein parameters respectively set for the scanning units; a signal generator; a reading unit; and an image processing unit, the image processing method comprising:
generating, by the signal generator, a signal for specifying an order of reading the image data from the image data storage unit and for specifying one of the parameter storage units that stores therein the parameter to be used for the read image data;
reading, by the reading unit, the image data in the order specified by the signal; and
performing, by the image processing unit, image processing on the read image data using the parameters stored in the parameter storage unit specified by the signal.
